(19) United States
(12) Patent Application Publication
(10) Pub. No.: US 2022/0020551 A1
(43) Pub. Date: Jan. 20, 2022

(54) SPECIAL-PURPOSE GROUND FAULT CIRCUIT BREAKER

(71) Applicant: Jiangsu Barep intelligence Technology Co.,Ltd, Zhangjiagang (CN)

(72) Inventors: Jiangang Chen, Zhangjiagang (CN); Xiaobo Zheng, Zhangjiagang (CN)

(21) Appl. No.: 17/449,668

(22) Filed: Oct. 1, 2021

(30) Foreign Application Priority Data
Sep. 9, 2021 (CN) 202111058666.9

(51) Int. Cl. H01H 71/50; H01H 71/02; H02H 3/16

(52) U.S. Cl. CPC H01H 71/50; H02H 3/16; H01H 71/02

(57) ABSTRACT

The present disclosure discloses a special-purpose ground fault circuit breaker, belonging to the technical field of sockets, which comprises at least two conductors, a socket box, a testing mechanism, a reset mechanism and a grounding connector, wherein the at least two conductors are electrically isolated, the reset mechanism comprises a moving arm, the moving arm and a power input terminal form one of the conductors, a socket silver point forms the other conductor, and the socket silver point and the power input terminal are fixedly installed in the socket box. The structure mechanism is simple, simplifying the internal structure of a leakage protection socket, reducing the manufacturing cost of the leakage protection socket, and reducing the manufacturing procedures.

### TECHNICAL FIELD

The present disclosure belongs to the technical field of sockets, and in particular relates to a special-purpose ground fault circuit breaker.

### BACKGROUND

The ground leakage protection socket, also known as a ground fault protection socket or a leakage protection socket, is a practical electrical product applied in the family residence to protect users from the hazards of electric leakage and electric shock. Because of its powerful protection function, the socket has been forcibly put into force and installed in some European and American countries. In North America, for example, each household user must install five ground fault protection sockets, which are places where electric leakage accidents easily occur with high humidity and concentrated electrical appliances, such as bathrooms and kitchens.

Chinese patent (CN201920294917.5) discloses an anti-misplug device for a socket and a leakage protection socket. The anti-misplug device comprises a slider frame, and a slider and an elastic member provided in the slider frame. The slider frame is provided with a plurality of notches corresponding to the shapes of the socket holes. The elastic member is provided so that the slider covers the socket hole in the initial state of the elastic member. The slider comprises at least two inclined planes. When an insert moves downwards while abutting against the at least two inclined planes, the slider is urged to move along the slider frame to expose the socket hole. The slider is provided with a balancing member abutting against the slider frame. The balancing member is arranged at the approximate middle position of the bottom of the slider, so that when the insert moves downward only against one of the inclined planes, the slider is turned over relative to the slider frame through the balancing member without exposing the socket hole.

At present, the internal structure and the action mechanism of tripping resetting and testing of a leakage protection socket are complex, resulting in poor tripping trigger sensitivity and tedious processing and manufacturing procedures.

### SUMMARY

The purpose of the present disclosure is to provide a special-purpose ground fault circuit breaker in order to solve the problems that the tripping resetting structure inside the leakage protection socket is complicated, resulting in poor trigger sensitivity, tedious processing and manufacturing procedures, and high processing cost.

In order to achieve the above purpose, the present disclosure adopts the following technical scheme: a special-purpose ground fault circuit breaker, comprising at least two conductors, a socket box, a testing mechanism, a reset mechanism and a grounding connector, wherein the at least two conductors are electrically isolated, the reset mechanism comprises a moving arm, the moving arm and a power input terminal form one of the conductors, a socket silver point forms the other conductor, the socket silver point and the power input terminal are fixedly installed in the socket box, the socket box is provided with a jack, the jack is aligned with the socket silver point, the reset mechanism and the testing mechanism are both provided in the socket box, the ends of the reset mechanism and the testing mechanism extend to the panel of the socket box, the reset mechanism is in contact with the socket silver point and the power input terminal, the grounding connector is fixedly installed in the socket box, and the grounding connector extends to the outside of the socket box.

As a further description of the above technical scheme:

the reset mechanism further comprises a reset button, a first guide rod, a lifter and a lock catch, the lifter is slidably provided in the socket box, the lock catch is inserted into the lifter from the side of the lifter, the lock catch is slidably provided on the elastic support mechanism, the first guide rod is slidably provided in the socket box, one end of the first guide rod is inserted into the lifter from the top of the lifter, the first guide rod is clamped on the lock catch, the reset button is fixedly connected to the other end of the first guide rod, one end of the moving arm is fixedly connected to the power input terminal, the lifter supports the bottom surface of the moving arm, the other end of the moving arm is attached to the socket silver point, a microswitch is provided in the socket box, the microswitch is located below the lifter, and the microswitch is in contact with the lifter.

As a further description of the above technical scheme:

one bent end of the lock catch is provided with a waist-shaped hole, the first guide rod is clamped in the waist-shaped hole, the other bent end of the lock catch is provided with a chute, the chute is clamped on the elastic support mechanism, and the chute slides up and down along the elastic support mechanism.

As a further description of the above technical scheme:

the microswitch and the elastic support mechanism are located on opposite sides of the lifter, respectively.

As a further description of the above technical scheme:

the elastic support mechanism comprises a guide post, a guide sleeve and a third spring, the guide sleeve is fixedly connected in the socket box, the guide post is slidably provided in the guide sleeve, the third spring is fixedly connected with the guide sleeve and the guide post, the chute is clamped on one end of the guide post, an electromagnetic coil is provided on the guide sleeve, and the electromagnetic coil is located at the other end of the guide post.

As a further description of the above technical scheme:

a slideway is provided in the socket box, the lifter is slidably provided in the slideway, a first spring is sleeved on the first guide rod, both ends of the first spring abut against the lifter and the reset button, respectively, a second spring is provided in the slideway, and the second spring abuts against the bottom of the lifter and the slideway, respectively.

As a further description of the above technical scheme:

the side wall of the lifter is provided with a boss, the top of the boss is provided with two step-shaped arc surfaces, and the arc surfaces support the bottom surface of the moving arm.

As a further description of the above technical scheme:

the testing mechanism comprises a test button, a second guide rod, and a conductive hook, the second guide rod is slidably provided in the socket box, the test button is fixedly installed on one end of the second guide rod, the conductive hook is fixedly installed on the other end of the second guide rod, the conductive hook abuts against the grounding connector, and the conductive hook hooks the socket silver point.

As a further description of the above technical scheme:

the conductive hook comprises a lever section and a hook section, the lever section is arranged at a certain angle with the hook section, the hook section is hooked below the socket silver point, the end of the lever section is fixedly connected to the second guide post, and the bottom surface of the lever section abuts against the grounding connector.

As a further description of the above technical scheme:

the moving arm and the conductive hook are both elastic metal sheets.

To sum up, due to the adoption of the technical scheme, the present disclosure has the following beneficial effects.

1. According to the present disclosure, by pressing a reset button, a first guide rod is inserted into the lock catch and is locked by the lock catch, a lifter presses a microswitch to turn on an analog leakage circuit, and a second spring elastically rebounds to drive the lifter to rise, thereby driving the moving arm to deform and be attached to the socket silver point to complete the reset operation. The structure mechanism is simple, greatly simplifying the internal structure of a leakage protection socket, reducing the manufacturing cost of the leakage protection socket, and reducing the manufacturing procedures.

2. According to the present disclosure, by pressing the test button, the second guide rod presses down the conductive hook. The conductive hook hooks on the socket silver point according to the lever principle. At this time, the electromagnetic coil magnetically attracts the guide post after being electrified so that the lock catch slides. After the waist-shaped hole on the lock catch is misaligned with the first guide rod, the first guide rod is released, the first guide rod releases the pull on the lifter, and the moving arm starts to reset and disconnect from the socket silver point. The structure mechanism is simple, which greatly simplifies the internal structure of the leakage protection socket, and improves the sensitivity of test.

### BRIEF DESCRIPTION OF THE DRAWINGS

FIG. 1 is a schematic diagram of the overall structure of a special-purpose ground fault circuit breaker.

FIG. 2 is a first schematic diagram of the internal structure of a special-purpose ground fault circuit breaker.

FIG. 3 is a second schematic diagram of the internal structure of a special-purpose ground fault circuit breaker.

FIG. 4 is a cross-sectional view of a reset mechanism in a special-purpose ground fault circuit breaker.

FIG. 5 is a schematic diagram of the overall structure of a reset mechanism in a special-purpose ground fault circuit breaker.

FIG. 6 is a schematic diagram of the structure of a lock catch in a special-purpose ground fault circuit breaker.

FIG. 7 is a schematic diagram of the structure of a conductive hook in a special-purpose ground fault circuit breaker.

### DESCRIPTION OF LEGEND

1. Socket box; 2. Testing mechanism; 21. Test button; 22. Second guide rod; 23. Conductive hook; 231. Lever section; 232. Hook section; 3. Reset mechanism; 31. Reset button; 32. First guide rod; 33. Lifter; 34. Moving arm; 35. Lock catch; 4. Socket silver dots; 5. Power input terminal; 6. Grounding connector; 7. Jack; 8. Elastic support mechanism; 81. Guide post; 82. Guide sleeve; 83. Third spring; 9. Microswitch; 10. Waist-shaped hole; 11. Chute; 12. Electromagnetic coil; 13. Slideway; 14. First spring; 15. Second spring; 16. Boss; 17. Arc surface.

### DETAILED DESCRIPTION OF THE EMBODIMENTS

The technical scheme in the embodiments of the present disclosure will be clearly and completely described hereinafter with reference to the drawings in the embodiments of the present disclosure. Obviously, the described embodiments are only part of the embodiments of the present disclosure, rather than all of the embodiments. Based on the embodiments of the present disclosure, all other embodiments obtained by those skilled in the art without paying creative labor belong to the scope of protection of the present disclosure.

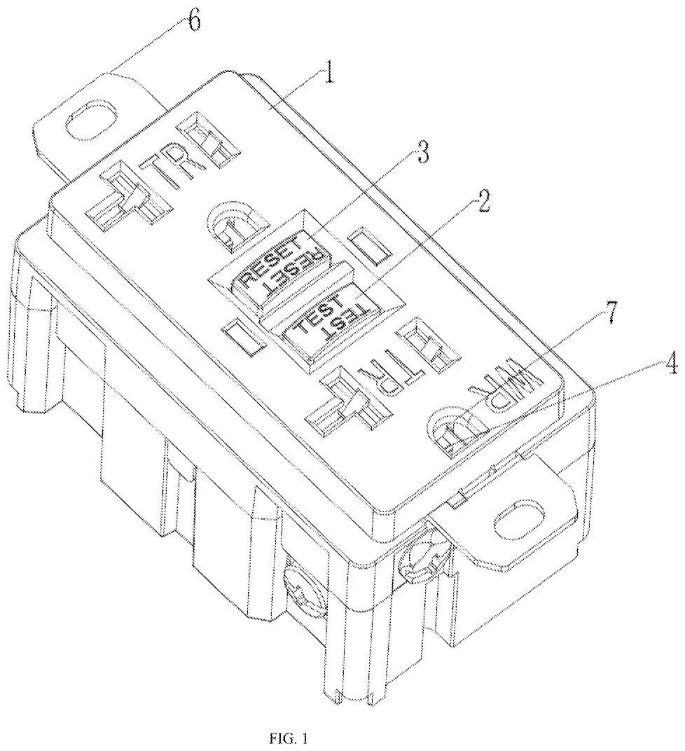

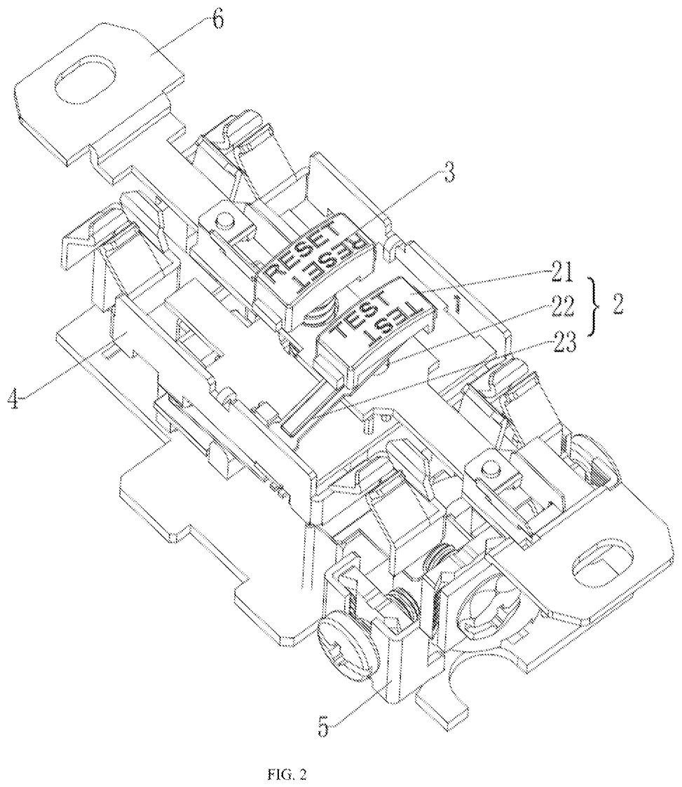

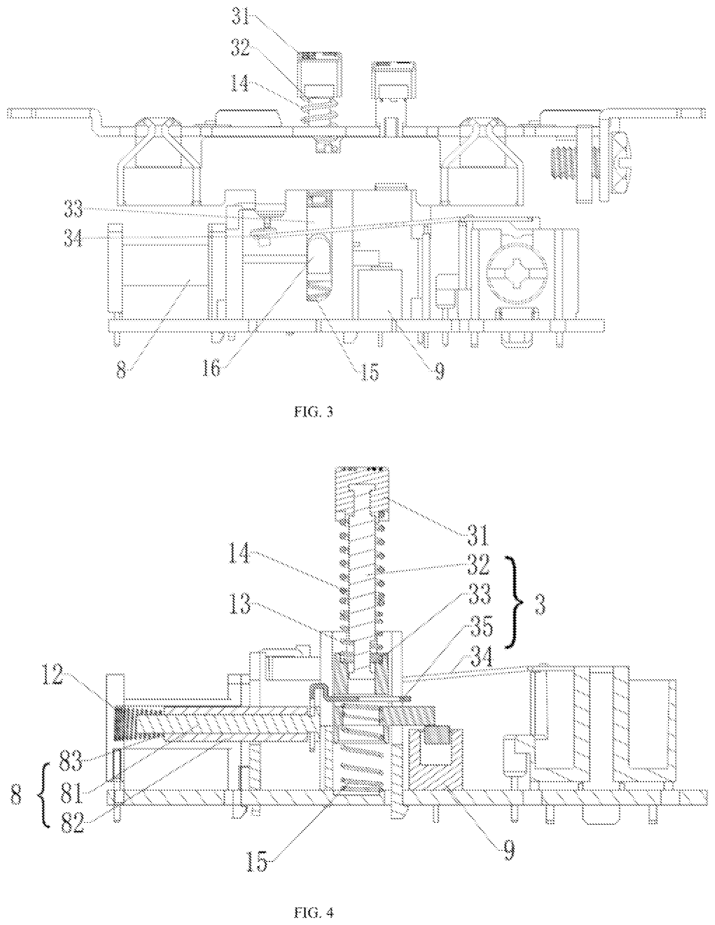

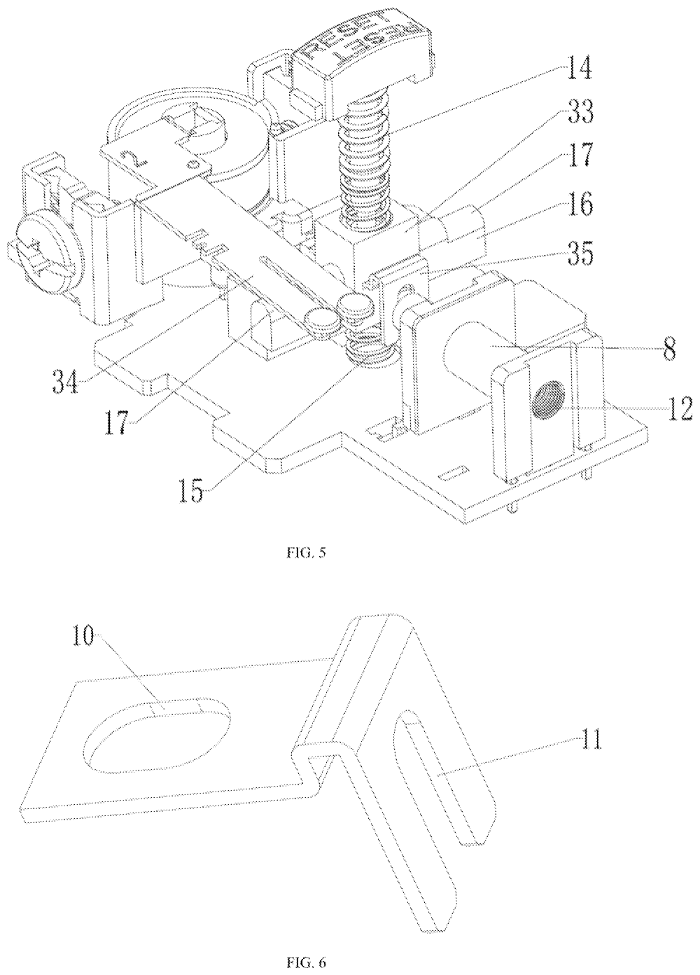

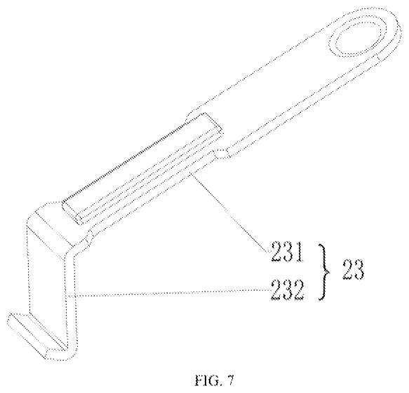

With reference to FIGS. 1-7, the present disclosure provides a technical scheme: a special-purpose ground fault circuit breaker comprises at least two conductors, a socket box 1, a testing mechanism 2, a reset mechanism 3 and a grounding connector 6, wherein the at least two conductors are electrically isolated, the reset mechanism 3 comprises a moving arm 34, the moving arm 34 and a power input terminal 5 form one of the conductors, a socket silver point 4 forms the other conductor, the socket silver point 4 and the power input terminal 5 are fixedly installed in the socket box 1, the socket box 1 is provided with a jack 7, the jack 7 is aligned with the socket silver point 4, the reset mechanism 3 and the testing mechanism 2 are both provided in the socket box 1, the ends of the reset mechanism 3 and the testing mechanism 2 extend to the panel of the socket box 1, the reset mechanism 3 is in contact with the socket silver point 4 and the power input terminal 5, the grounding connector 6 is fixedly installed in the socket box 1, and the grounding connector 6 extends to the outside of the socket box 1.

The reset mechanism 3 comprises a reset button 31, a first guide rod 32, a lifter 33 and a lock catch 35, the lifter 33 is slidably provided in the socket box 1, the lock catch 35 is inserted into the lifter 33 from the side of the lifter 33, the lock catch 35 is slidably provided on the elastic support mechanism 8, the first guide rod 32 is slidably provided in the socket box 1, one end of the first guide rod 32 is inserted into the lifter 33 from the top of the lifter 33, the first guide rod 32 is clamped on the lock catch 35, the reset button 31 is fixedly connected to the other end of the first guide rod 32, one end of the moving arm 34 is fixedly connected to the power input terminal 5, the lifter 33 supports the bottom surface of the moving arm 34, the other end of the moving arm 34 is attached to the socket silver point 4, a microswitch 9 is provided in the socket box 1, the microswitch 9 is located below the lifter 33, and the microswitch 9 is in contact with the lifter 33.

One bent end of the lock catch 35 is provided with a waist-shaped hole 10, the first guide rod 32 is clamped in the waist-shaped hole 10, the other bent end of the lock catch 35 is provided with a chute 11, the chute 11 is clamped on the elastic support mechanism 8, and the chute 11 slides up and down along the elastic support mechanism 8. When the first guide rod 32 is pressed, the first guide rod 32 squeezes the lock catch 35 to slide in the lifter 33. The chute 11 on the lock catch 35 adaptively slides up and down along the guide post 81, so that the end of the first guide rod 32 is inserted into the waist-shaped hole 10, and the lock catch 35 firmly clamps the first guide rod 32.

The microswitch 9 and the elastic support mechanism 8 are located on opposite sides of the lifter 33, respectively.

The elastic support mechanism 8 comprises a guide post 81, a guide sleeve 82 and a third spring 83, the guide sleeve 82 is fixedly connected in the socket box 1, the guide post 81 is slidably provided in the guide sleeve 82, the third spring 83 is fixedly connected with the guide sleeve 82 and the guide post 81, the chute 11 is clamped on one end of the guide post 81, an electromagnetic coil 12 is provided on the guide sleeve 82, and the electromagnetic coil 12 is located at the other end of the guide post 81. The electromagnetic coil 12 attracts the guide post 81 after being electrified so that the guide post 81 slides in the guide sleeve 82. The guide post 81 slides to pull the lock catch 35 to displace in the lifter 33, so that the position of the waist-shaped hole 10 on the lock catch 35 changes, thus releasing the lock catch 35 from limiting the first guide rod 32. The first guide rod 32 rises under the elastic action of the first spring 14 and the second spring 15.

A slideway 13 is provided in the socket box 1, the lifter 33 is slidably provided in the slideway 13, a first spring 14 is sleeved on the first guide rod 32, both ends of the first spring 14 abut against the lifter 33 and the reset button 31, respectively, a second spring 15 is provided in the slideway 13, and the second spring 15 abuts against the bottom of the lifter 33 and the slideway 13, respectively, which is beneficial for the lifter 33 and the first guide rod 32 to quickly return to the initial state after releasing the limit.

The side wall of the lifter 33 is provided with a boss 16, the top of the boss 16 is provided with two step-shaped arc surfaces 17, and the arc surfaces 17 support the bottom surface of the moving arm 34. The boss 16 deforms the moving arm 34 with the lifting action of the lifter 33, so that the moving arm 34 is attached to the socket silver point 4. The arc surfaces 17 reduce the friction between the socket silver point and the moving arm 34, so that the deformation of the moving arm 34 is more sensitive.

The testing mechanism 2 comprises a test button 21, a second guide rod 22, and a conductive hook 23, the second guide rod 22 is slidably provided in the socket box 1, the test button 21 is fixedly installed on one end of the second guide rod 22, the conductive hook 23 is fixedly installed on the other end of the second guide rod 22, the conductive hook 23 abuts against the grounding connector 6, and the conductive hook 23 hooks the socket silver point 4. The test button 21 is pressed, the second guide rod 22 presses down the conductive hook 23, and the conductive hook 23 hooks the socket silver point 4 under the lever action, so as to perform the test operation.

The conductive hook 23 comprises a lever section 231 and a hook section 232, the lever section 231 is arranged at a certain angle with the hook section 232, the hook section 232 is hooked below the socket silver point 4, the end of the lever section 231 is fixedly connected to the second guide post 81, and the bottom surface of the lever section 231 abuts against the grounding connector 6.

The moving arm 34 and the conductive hook 23 are both elastic metal sheets, which is beneficial for the moving arm 34 and the conductive hook 23 to have sufficient deformation during use and elastically rebound to the initial state after deformation.

Working principle: first, when reset operation is needed, the reset button 31 is pressed, the first guide rod 32 slides along the socket box 1, and the lifter 33 slides along the slideway 13 under the action of the first guide rod 32. At this time, the first spring 14 and the second spring 15 are compressed. The first guide rod 32 is in contact with the lock catch 35. The lock catch 35 releases the degree of freedom in the horizontal direction. The lock catch 35 slides horizontally in the lifter 33. The guide post 81 slides along the guide sleeve 82 under the action of the lock catch 35. Second, when the waist-shaped hole 10 on the lock catch 35 aligns with the first guide rod 32, the first guide rod 32 is inserted into the waist-shaped hole 10. Under the elastic action of the third spring 83, the lock catch 35 firmly clamps the first guide rod 32. The lifter 33 touches the microswitch 9 therebelow in the lifting process. The analog leakage circuit is turned on. The second spring 15 starts to reset. The lifter 33 slides upwards along the slideway 13 under the elastic action of the second spring 15. The chute 11 on the lock catch 35 slides along the guide post 81. The arc surface 17 on the boss 16 squeezes the moving arm 34 to bend upwards, so that the moving arm 34 is in contact with the socket silver point 4. Current flows between the socket silver point 4 and the power input terminal 5. Thereafter, when a test operation is needed, the test button 21 is pressed, and the second guide rod 22 slides downwards along the socket box 1. The second guide rod 22 acts on the conductive hook 23. The lever section 231 on the conductive hook 23 rotates under the support of the grounding connector 6, driving the hook section 232 to move upwards, so that the hook section 232 is in contact with the socket silver point 4. At this time, the electromagnetic coil 12 obtains power. Finally, the electromagnetic coil 12 magnetically attracts the guide post 81 to slide in the guide sleeve 82 after being energized. The guide post 81 pulls the lock catch 35 to slide horizontally in the lifter 33. The waist-shaped hole 10 gradually moves away from the position of the first guide rod 32 and releases the restriction on the degree of freedom of the first guide rod 32. The first spring 14 elastically rebounds. The first guide rod 32 slides upwards along the socket box 1 under the elastic action of the first spring 14. After losing the tensile force of the first guide rod 32, the lifter 33 can no longer squeeze the moving arm 34 against the socket silver point 4. The moving arm 34 is reset under its own elastic action, and the moving arm 34 is disconnected from the socket silver point 4 to complete the reset.

The above is only a preferred embodiment of the present disclosure, but the protection scope of the present disclosure is not limited thereto. Any equivalent substitution or change made by those skilled in the art according to the technical scheme and inventive concept of the present disclosure within the technical scope disclosed by the present disclosure shall be covered within the protection scope of the present disclosure.

What is claimed is:

1. A special-purpose ground fault circuit breaker, comprising at least two conductors, a socket box (1), a testing mechanism (2), a reset mechanism (3) and a grounding connector (6), wherein the at least two conductors are electrically isolated, the reset mechanism (3) comprises a moving arm (34), the moving arm (34) and a power input terminal (5) form one of the conductors, a socket silver point (4) forms the other conductor, the socket silver point (4) and the power input terminal (5) are fixedly installed in the socket box (1), the socket box (1) is provided with a jack (7), the jack (7) is aligned with the socket silver point (4), the reset mechanism (3) and the testing mechanism (2) are both provided in the socket box (1), the ends of the reset mechanism (3) and the testing mechanism (2) extend to the panel of the socket box (1), the reset mechanism (3) is in contact with the socket silver point (4) and the power input terminal (5), the grounding connector (6) is fixedly installed in the socket box (1), and the grounding connector (6) extends to the outside of the socket box (1).

2. The special-purpose ground fault circuit breaker according to claim 1, wherein the reset mechanism (3) further comprises a reset button (31), a first guide rod (32), a lifter (33) and a lock catch (35), the lifter (33) is slidably provided in the socket box (1), the lock catch (35) is inserted into the lifter (33) from the side of the lifter (33), the lock catch (35) is slidably provided on the elastic support mechanism (8), the first guide rod (32) is slidably provided in the socket box (1), one end of the first guide rod (32) is inserted into the lifter (33) from the top of the lifter (33), the first guide rod (32) is clamped on the lock catch (35), the reset button (31) is fixedly connected to the other end of the first guide rod (32), one end of the moving arm (34) is fixedly connected to the power input terminal (5), the lifter (33) supports the bottom surface of the moving arm (34), the other end of the moving arm (34) is attached to the socket silver point (4), a microswitch (9) is provided in the socket box (1), the microswitch (9) is located below the lifter (33), and the microswitch (9) is in contact with the lifter (33).

3. The special-purpose ground fault circuit breaker according to claim 2, wherein the lock catch (35) has an L-shaped structure, one bent end of the lock catch (35) is provided with a waist-shaped hole (10), the first guide rod (32) is clamped in the waist-shaped hole (10), the other bent end of the lock catch (35) is provided with a chute (11), the chute (11) is clamped on the elastic support mechanism (8), and the chute (11) slides up and down along the elastic support mechanism (8).

4. The special-purpose ground fault circuit breaker according to claim 3, wherein the microswitch (9) and the elastic support mechanism (8) are located on opposite sides of the lifter (33), respectively.

5. The special-purpose ground fault circuit breaker according to claim 4, wherein the elastic support mechanism (8) comprises a guide post (81), a guide sleeve (82) and a third spring (83), the guide sleeve (82) is fixedly connected in the socket box (1), the guide post (81) is slidably provided in the guide sleeve (82), the third spring (83) is fixedly connected with the guide sleeve (82) and the guide post (81), the chute (11) is clamped on one end of the guide post (81), an electromagnetic coil (12) is provided on the guide sleeve (82), and the electromagnetic coil (12) is located at the other end of the guide post (81).

6. The special-purpose ground fault circuit breaker according to claim 2, wherein a slideway (13) is provided in the socket box (1), the lifter (33) is slidably provided in the slideway (13), a first spring (14) is sleeved on the first guide rod (32), both ends of the first spring (14) abut against the lifter (33) and the reset button (31), respectively, a second spring (15) is provided in the slideway (13), and the second spring (15) abuts against the bottom of the lifter (33) and the slideway (13), respectively.

7. The special-purpose ground fault circuit breaker according to claim 2, wherein the side wall of the lifter (33) is provided with a boss (16), the top of the boss (16) is provided with two step-shaped arc surfaces (17), and the arc surfaces (17) support the bottom surface of the moving arm (34).

8. The special-purpose ground fault circuit breaker according to claim 2, wherein the testing mechanism (2) comprises a test button (21), a second guide rod (22), and a conductive hook (23), the second guide rod (22) is slidably provided in the socket box (1), the test button (21) is fixedly installed on one end of the second guide rod (22), the conductive hook (23) is fixedly installed on the other end of the second guide rod (22), the conductive hook (23) abuts against the grounding connector (6), and the conductive hook (23) hooks the socket silver point (4).

9. The special-purpose ground fault circuit breaker according to claim 8, wherein the conductive hook (23) comprises a lever section (231) and a hook section (232), the lever section (231) is arranged at a certain angle with the hook section (232), the hook section (232) is hooked below the socket silver point (4), the end of the lever section (231) is fixedly connected to the second guide post (81), and the bottom surface of the lever section (231) abuts against the grounding connector (6).

10. The special-purpose ground fault circuit breaker according to claim 8, wherein the moving arm (34) and the conductive hook (23) are both elastic metal sheets.
